(19) United States
(12) Patent Application Publication
(10) Pub. No.: US 2020/0305568 A1
(43) Pub. Date: Oct. 1, 2020

(54) METHOD FOR ATTACHING METAL ORNAMENT ONTO LEATHER PRODUCT

(71) Applicant: You Han LEE, Namyangju-si (KR)

(72) Inventors: You Han LEE, Namyangju-si (KR); Jong Soo SEO, Incheon (KR)

(21) Appl. No.: 16/512,928

(22) Filed: Jul. 16, 2019

(30) Foreign Application Priority Data
Mar. 27, 2019 (KR) 10-2019-0034755

(51) Int. Cl. A45C 13/00; B23K 26/352; B23K 26/00

(52) U.S. Cl. CPC A45C 13/001; B23K 26/0006; B23K 26/352

(57) ABSTRACT

Provided is a method for attaching a metal ornament onto a leather product to prevent the metal ornament from being lifted from the surface of the leather product during usage. The method includes forming an attaching groove of a predetermined shape by burning a part of a surface of a leather material with a laser beam; temporarily fitting and attaching a metal sticker of a corresponding shape to the attaching groove; and placing a stiffening plate, of which a rear surface is applied by an adhesive, on a rear surface of the leather material at a position corresponding to the metal sticker, and simultaneously attaching the metal sticker and the stiffening plate onto the leather material through thermal bonding.

### BACKGROUND OF THE INVENTION

### Field of the Invention

The present invention relates to a method for attaching a metal ornament indicative of identity, such as a trademark, a logo, a design, a product name, or a company name, onto surfaces of various leather products, such as a wallet, a bag, or a leather case, and more particularly, to a method for attaching a metal ornament onto a leather product that can prevent a leather from being damaged due to thermal deformation or prevent the metal ornament from being damaged due to an external force or from being detached from the surface of the leather in the process of attaching the metal ornament onto the surface of the leather product.

### Background of the Related Art

In general, various metal ornaments, which represent identity, such as a trademark including symbols, characters or patterns, a logo, a design, a product name, or a company name, are attached onto surfaces of various leather products, such as a wallet, a bag, or a leather case, to increase the customer's trust in the brand and quality of the corresponding company. Also, it can decorate the product to develop aesthetic sense of the product.

A so-called metal sticker made of a metallic material which generally represents a gold or silver color to give advanced impression is used as the metal ornament.

In case where the metal sticker is attached to a hard material, such as plastic, an attached state can be stably maintained. However, in case of leather material, since the material has an inherent property which is flexible and thus folded or bent, the metal sticker is folded or bent by impact or an external force applied from the outside, so that the metal sticker is lifted from the surface of the leather material, thereby decreasing the quality and reliability of the product, and causing a user to be cut or injured by a sharp portion of the metal sticker.

In order to solve the above problem of the related art, a method is disclosed in Korean Patent No. 10-1233011, in which the surface of the leather product is provided with a recessed portion by a mold or a laser cutting method, and then a metal ornament is attached to the recessed portion by thermal fusion.

However, in the process of forming the recessed portion on the surface of the leather product by a laser cutter, the leather is deformed or damaged by the heat generated from the laser, and an edge of the recessed portion is scorched, thereby increasing a defect rate.

Also, since the metal ornament of an irregular shape is simply attached to the recessed portion by an adhesive, the metal ornament is lifted from the surface of the leather by impact or an external force applied from the outside while the leather product is using, thereby remarkably decreasing its durability.

In addition, since the irregular edge of the metal ornament is exposed, the user can be injured, or the clothes are damaged by scratch.

Meanwhile, the leather material is coated by polyurethane resin for protecting the surface of a skin layer and giving smooth texture, or by enamel for improving durability, water resistance and heat resistance and giving a luxurious feeling.

In case where the metal sticker is directly attached to the surface of the leather material by the adhesive, the metal sticker is not strongly attached thereto, but is easily detached therefrom, due to the coating layer applied to the leather material.

### SUMMARY OF THE INVENTION

Therefore, the present invention has been made in view of the technical limits and the problems of the related art that attaches a metal ornament onto a leather product. The present invention has been devised from efforts and researches of the inventors to prevent a surface of the leather product from being thermally deformed in a process of partially removing the surface through laser cutting and to prevent a metal sticker (i.e., metal ornament) from being lifted from the surface of the leather product or deformed by reinforcing the metal sticker so that even in a state in which the metal sticker is attached to the surface of the leather product, the metal sticker is not flexibly folded or bent by an external force.

Accordingly, one object of the present invention is to provide a method for attaching a metal ornament onto a leather product to prevent a leather material from being deformed and damaged due to heat generated during a laser cutting process.

Another object of the present invention is to provide a method for attaching a metal ornament onto a leather product to reliably prevent a metal sticker from being lifted from a surface of a leather material.

According to the first aspect of the present invention, there is provided a method for attaching a metal ornament onto a leather product comprising the steps of: forming an attaching groove of a predetermined shape by burning a part of a surface of a leather material with a laser beam; temporarily fitting and attaching a metal sticker of a corresponding shape to the attaching groove; and placing a stiffening plate, of which a rear surface is applied by an adhesive, on a rear surface of the leather material at a position corresponding to the metal sticker, and simultaneously attaching the metal sticker and the stiffening plate onto the leather material through thermal bonding.

With the above configuration, even though the metal sticker is applied by an external force, the metal sticker is not flexibly folded or bent by the stiffening plate, thereby effectively preventing the metal sticker from being lifted from the surface of the leather material.

According to the second aspect of the present invention, there is provided a method for attaching a metal ornament onto a leather product comprising the steps of: coating a part of a surface of a leather material with surfactant to form a thin film; forming an attaching groove of a predetermined shape by burning a part of a surface of a leather material with a laser beam; removing the thin film of the surfactant and flecks from the leather material; temporarily fitting and attaching a metal sticker of a corresponding shape to the attaching groove; and placing a stiffening plate, of which a rear surface is applied by an adhesive, on a rear surface of the leather material at a position corresponding to the metal sticker, and simultaneously attaching the metal sticker and the stiffening plate onto the leather material through thermal bonding.

With the above configuration, even though the metal sticker is applied by an external force, the metal sticker is not flexibly folded or bent by the stiffening plate, thereby effectively preventing the metal sticker from being lifted from the surface of the leather material. Also, it is possible to prevent the leather from being thermally deformed and damaged by a protective effect of the surfactant in the laser cutting process.

According to the third aspect of the present invention, there is provided a method for attaching a metal ornament onto a leather product comprising the steps of: removing a surface coating of a predetermined shape by burning a part of a surface of a leather material with a laser beam; forming an attaching groove on the surface of the leather material, from which the surface coating is removed, through hot stamping; temporarily fitting and attaching a metal sticker of a corresponding shape to the attaching groove; and placing a stiffening plate, of which a rear surface is applied by an adhesive, on a rear surface of the leather material at a position corresponding to the metal sticker, and simultaneously attaching the metal sticker and the stiffening plate onto the leather material through thermal bonding.

With the above configuration, even though the metal sticker is applied by an external force, the metal sticker is not flexibly folded or bent by the stiffening plate, thereby effectively preventing the metal sticker from being lifted from the surface of the leather material. Also, since the attaching groove is formed after the surface coating of the lather material is formed, it is possible to further firmly attach the metal sticker.

According to an embodiment, the attaching groove is formed to have a depth equal to or deeper than a thickness of the metal sticker, so that the edge of the metal sticker is not exposed from the surface of the leather material, but is maintained in the stable and strong attached state.

Therefore, with the above configuration, even though the metal sticker (i.e., metal ornament) attached to the surface of the leather product is applied by an external force, the metal sticker is not flexibly folded or bent by the stiffening plate, thereby preventing the metal sticker from being lifted from the surface of the leather material or being deformed.

Also, it is possible to prevent the leather material from being thermally deformed and damaged in the laser cutting process by the protective effect of the thin film of surfactant, thereby reducing a defect rate of the leather product.

In addition, since the attaching groove is formed after the surface coating attached to the surface of the leather material is removed, the adhesive force is increased to strongly attach the metal sticker.

### BRIEF DESCRIPTION OF THE DRAWINGS

FIGS. 1A, 1B and 1C are process flow views schematically illustrating a process of attaching a metal ornament onto a leather product according to the first embodiment of the present invention.

FIGS. 2A, 2B, 2C, 2D and 2E are process flow views schematically illustrating a process of attaching a metal ornament onto a leather product according to the second embodiment of the present invention.

FIGS. 3A, 3B, 3C and 3D are process flow views schematically illustrating a process of attaching a metal ornament onto a leather product according to the third embodiment of the present invention.

### DETAILED DESCRIPTION OF THE PREFERRED EMBODIMENT

Now, preferred embodiments of the present invention will be described in detail with reference to the accompanying drawings.

In the following description, the terminology used herein is for the purpose of describing particular embodiments only and is not intended to limit the right scope of the invention. Unless otherwise defined, all terms used herein have the same meaning as commonly understood by one of ordinary skill in the art to which this invention pertains, and should not be interpreted as having an excessively comprehensive meaning nor as having an excessively contracted meaning.

Detailed descriptions of well-known functions or constructions will be omitted since they would obscure the invention in unnecessary detail.

The accompanying drawings are used to help easily understand the technical idea of the present invention, and it should be understood that the idea of the present invention is not limited by the accompanying drawings.

Also, the term “and/or” covers embodiments having element A alone, element B alone, or elements A and B taken together.

As used herein, the singular forms “a,” “an” and “the” are intended to include the plural forms as well, unless the context clearly indicates otherwise. In the present application, such terminology as ‘configured’, ‘include’ and the like should be construed not as necessarily including various components or steps written in the present specification but as including the components or steps in part or further including additional components or steps.

Incidentally, it is assumed that front, rear, left, right, upward, and downward viewing directions are expediently used to distinguish the relative position of the respective components. For example, the upper direction of the drawing will be referred to an upper portion, a longitudinal direction will be referred to back and forth directions, and a width direction will be referred to left and right directions.

It will be understood that, although the terms “first” “second”, etc., may be used herein to distinguish one element from another element, the terms are not meant to be limiting. These terms are only used to distinguish one element from another. For example, a first element could be termed a second element, and, similarly, a second element could be termed a first element, without departing from the scope of example embodiments.

### Embodiment 1

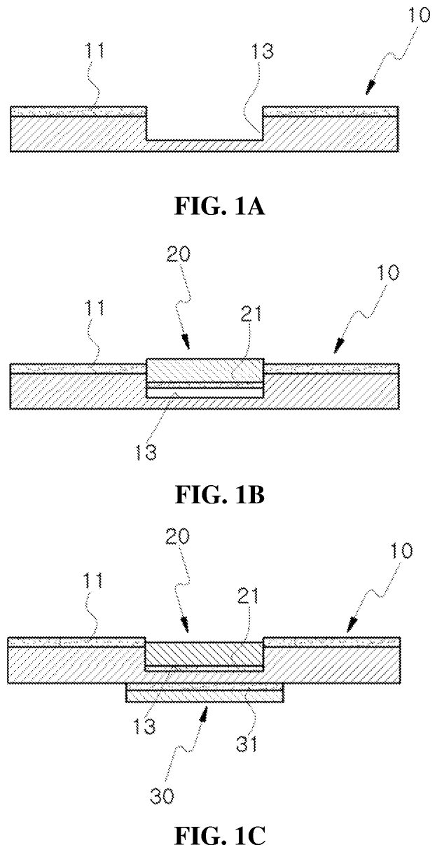

Referring to FIGS. 1A, 1B, and 1C, a method for attaching a metal ornament onto a leather product according to the first embodiment of the present invention generally includes a process (A) of forming an attaching groove, a process (B) of temporarily attaching a metal sicker, and a thermal bonding process (C).

(A) Process of Forming Attaching Groove

As illustrated in FIG. 1A, the process is to precisely burn a part of the surface of a leather material (10) by a laser cutter so that the surface has a predetermined pattern to form an attaching groove 13 of a desired pattern.

The attaching groove 13 may be formed in the same pattern as an outer (flange) pattern of a metal sicker 20, such as a trademark, a logo, a design, a product name, or a company name.

That is, the attaching groove 13 of various designs or patterns can be precisely and effectively formed by the laser cutter.

For example, in case of attaching the metal sticker 20 of an ‘ABC’ shape onto the surface of the leather material 10, the surface of the leather material 10 may be provided with the attaching groove 13 by removing the surface of the leather material 10 with the laser cutter so that the surface is recessed to have the same shape as the metal sticker 20 or the corresponding ‘ABC’ shape.

Alternatively, in case of attaching the metal sticker 20 of an ‘⋆’ shape onto the surface of the leather material 10, the surface of the leather material 10 may be provided with the attaching groove 13 by removing the surface of the leather material 10 with the laser cutter so that the surface is recessed to have the same shape as the metal sticker 20 or the corresponding ‘⋆’ shape.

The attaching groove 13 may be formed to have the same depth as a thickness of the metal sticker 20, or to have a depth deeper than that of the metal sticker.

In other words, preferably, the attaching groove 13 guides and support the metal sticker 20 so that the metal sticker does not protrude higher than the surface of the leather material 10, and is maintained in a strongly attached state, and an edge of the metal sticker 20 is not exposed from the surface of the leather material 10 to prevent a user from being injured or the clothes from being damaged due to the protruding edge of the metal sticker.

For example, if the metal sticker 20 is 0.07 to 0.3 mm in thickness, the attaching groove 13 may have a depth of 0.1 to 0.35 mm.

The leather material 10 of the present invention has been subjected to a proper process including chemical and mechanical treatment, such as tanning, dyeing, and painting.

(B) Process of Temporarily Attaching Metal Sticker

As illustrated in FIG. 1B, the process is to temporarily fit and attach the metal sticker 20 having the corresponding shape onto the attaching groove 13.

That is, the metal sticker 20 is preheated so that the metal sticker is temporarily and preliminarily fixed before the metal sticker is bonded integrally with the leather material 10 by a thermal bonding machine.

The metal sticker 20 may be formed in a certain shape, such as a trademark, a logo, a design, a product name, or a company name, and have a bottom surface with an adhesive 21.

(C) Thermal Bonding Process

As illustrated in FIG. 1C, the process is to thermally bond the metal sticker 20 and a stiffening plate 30 after the stiffening plate 30 with the adhesive 31 applied on the bottom surface is put on the rear surface of the leather material 10 at a position corresponding to the metal sticker 20, and then the metal sticker and the stiffening plate are positioned on a jig of the thermal bonding machine.

That is, the metal sticker 20 and the stiffening plate 30 which is placed between an upper plate jig and a lower plate jig are attached onto the leather material 10 by applying heat and pressure to the surfaces of the metal sticker and the stiffening plate.

The thermal bonding process is preferably performed in the range of pressure of 2 to 10 kg/cm² during 5 to 10 seconds at the temperature of 170 to 190° C.

In this instance, in case where the temperature of the thermal bonding is lower than 170° C., the bonding effect is very limited. In case where the temperature of the thermal bonding is higher than 190° C., the leather material 10 is burned to the metal sticker 20.

Also, in case where the time of the thermal bonding is less than 5 seconds, the bonding effect is very limited. In case where the time of the thermal bonding is more than 10 seconds, the leather material 10 is burned to the metal sticker 20 due to excessive fusion.

The shape (flange) of the stiffening plate 30 and the shape (flange) of the jig of the thermal bonding machine may be similar to or identical to the shape (flange) of the metal sticker 20.

The stiffening plate 30 preferably employs stainless steel having a thickness of 1.5 mm or less and an area slightly larger than that of the flange of the metal sticker 20.

According to the above manufacturing process, the inner edge of the attaching groove 13 is slightly shrunk in the thermal bonding process to enclose the flange of the metal sticker 20 in a covering manner, so that the flange of the metal sticker 20 is not exposed from the surface of the leather material 10, but is more stably and firmly attached onto the leather material in the state of being buried inside the attaching groove 13.

In addition, even though the metal sticker 20 is applied by an external force, the metal sticker is not flexibly folded or bent by the stiffening plate 30, thereby effectively preventing the metal sticker from being lifted from the surface of the leather material 10, or from being deformed.

### Embodiment 2

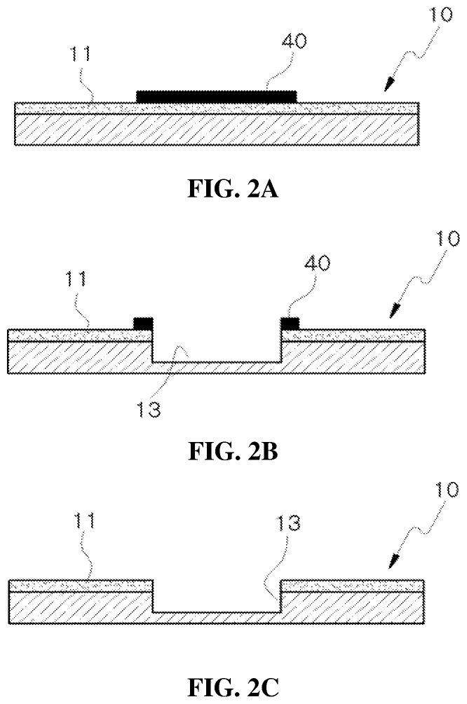

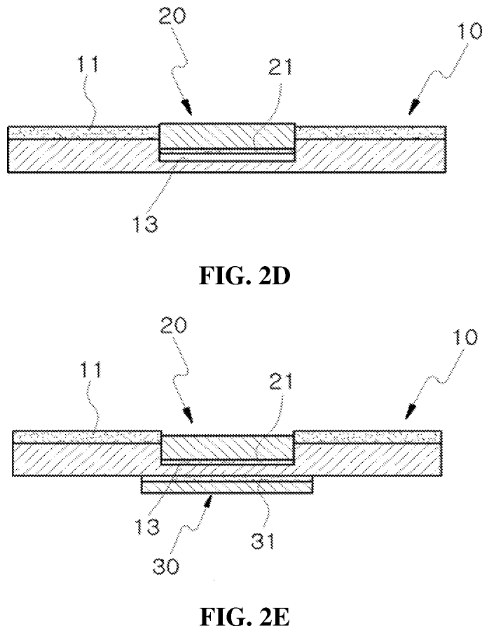

Referring to FIG. 2A, 2B, 2C, 2D and 2E, a method for attaching a metal ornament onto a leather product according to the second embodiment of the present invention generally includes a process (A) of forming a thin film of surfactant, a process (B) of forming an attaching groove, a process (C) of removing the thin film of the surfactant and flecks, a process (D) of temporarily attaching a metal sicker, and a thermal bonding process (E).

(A) Process of Forming Thin Film of Surfactant

As illustrated in FIG. 2A, the process is to form a thin film (40) of surfactant by partially applying the surfactant onto the surface of the leather material 10 and then drying the surfactant.

The thin film 40 of surfactant is preferably formed by applying the surfactant in a thickness of 10 μm or less and an area slightly larger than that of the metal sticker 20.

Also, the method of forming the thin film 40 of surfactant includes the prior art, such as a spray method, a knife edge method (knife coating), and a roller method (roll coating), an infrared lamp and a hot air drier.

The surfactant includes anionic surfactants which are dissolved in water, but are not ionized to water, and have high surficial humidity, nonionic surfactants, and a combination thereof.

For example, the anionic surfactant may be any one selected from a group consisting of alkyl sulfate, alkyl-ether sulfate, alkyl sulfonate, alkyl-ether sulfonate, alkyl phosphate, alkyl-ether phosphate, alky carbonate, alkyl-ether carbonate, laureth sulfonate, isotridecyl sulfonate, naphthalene sulfonate, dibutyl naphthyl sulfonate, nonylbenzene sulfonate, dedecylbenzene sulfonate, isotridecyl benzene sulfonate, and stearyl sulfate.

The nonionic surfactant may be any one selected from a group consisting of polyoxyethylene alkyl ether, polyoxyethylene fatty acid ether, polyoxyethylene alkyl phenol ether, sorbitan fatty acid ester, polyoxyethylene sorbitan esters of fatty acids, and sucrose fatty acid ester.

The leather material 10 of the present invention has been subjected to a proper process including chemical and mechanical treatment, such as tanning, dyeing, and painting.

(B) Process of Forming Attaching Groove

As illustrated in FIG. 2B, the process is to precisely burn a part of the surface of a leather material (10) under the thin film (10) of surfactant by a laser cutter so that the surface has a predetermined pattern to form an attaching groove 13 of a desired pattern.

In this instance, it is possible to prevent the edge of the attaching groove 13 from being scorched or deformed due to the heat of the laser.

More specifically, the thin film 40 of surfactant has some advantages of significantly decreasing a thermal phenomenon caused by irradiation of a laser beam, minimizing the edge of the attaching groove 13 from being thermally deformed, decreasing an attaching force of the surface by cooling flecks of the leather material 10 which are produced at laser cutting to prevent a fusion phenomenon, and preventing pollution caused by the flecks and easily removing the flecks by an effect of a protective film.

The attaching groove 13 may be formed in the same pattern as an outer (flange) pattern of a metal sicker 20, such as a trademark, a logo, a design, a product name, or a company name.

That is, the attaching groove 13 of various designs or patterns can be precisely and effectively formed by the laser cutter.

For example, in case of attaching the metal sticker 20 of an ‘ABC’ shape onto the surface of the leather material 10, the surface of the leather material 10 may be provided with the attaching groove 13 by removing the surface of the leather material 10 with the laser cutter so that the surface is recessed to have the same shape as the metal sticker 20 or the corresponding ‘ABC’ shape.

Alternatively, in case of attaching the metal sticker 20 of an ‘⋆’ shape onto the surface of the leather material 10, the surface of the leather material 10 may be provided with the attaching groove 13 by removing the surface of the leather material 10 with the laser cutter so that the surface is recessed to have the same shape as the metal sticker 20 or the corresponding ‘⋆’ shape.

The attaching groove 13 may be formed to have the same depth as a thickness of the metal sticker 20, or to have a depth deeper than that of the metal sticker.

In other words, preferably, the attaching groove 13 guides and support the metal sticker 20 so that the metal sticker does not protrude higher than the surface of the leather material 10, and is maintained in a strongly attached state, and an edge of the metal sticker 20 is not exposed from the surface of the leather material 10 to prevent a user from being injured or the clothes from being damaged due to the protruding edge of the metal sticker.

For example, if the metal sticker 20 is 0.07 to 0.3 mm in thickness, the attaching groove 13 may have a depth of 0.1 to 0.35 mm.

(C) Process of Removing Thin Film of Surfactant and Flecks

As illustrated in FIG. 2C, the process is to remove the thin film 40 of surfactant applied on the surface of the leather material 10, and the flecks of the leather material produced at the laser cutting.

The thin film 40 of surfactant and the flecks may be removed by a washing device of the prior art which injects water, such as an air nozzle or a water jet.

(D) Process of Temporarily Attaching Metal Sticker

As illustrated in FIG. 2D, the process is to temporarily fit and attach the metal sticker 20 having the corresponding shape onto the attaching groove 13.

That is, the metal sticker 20 is preheated so that the metal sticker is temporarily and preliminarily fixed before the metal sticker is bonded integrally with the leather material 10 by a thermal bonding machine.

The metal sticker 20 may be formed in a certain shape, such as a trademark, a logo, a design, a product name, or a company name, and have a bottom surface with an adhesive 21.

(E) Thermal Bonding Process

As illlustrated in FIG. 2E, the process is to thermally bond the metal sticker 20 and the stiffening plate 30 after the stiffening plate 30 with the adhesive 31 applied on the bottom surface is put on the rear surface of the leather material 10 at a position corresponding to the metal sticker 20, and then the metal sticker and the stiffening plate are positioned on a jig of the thermal bonding machine.

That is, the metal sticker 20 and the stiffening plate 30 which is placed between an upper plate jig and a lower plate jig are attached onto the leather material 10 by applying heat and pressure to the surfaces of the metal sticker and the stiffening plate.

The thermal bonding process is preferably performed in the range of pressure of 2 to 10 kg/cm² during 5 to 10 seconds at the temperature of 170 to 190° C.

In this instance, in case where the temperature of the thermal bonding is lower than 170° C., the bonding effect is very limited. In case where the temperature of the thermal bonding is higher than 190° C., the leather material 10 is burned to the metal sticker 20.

Also, in case where the time of the thermal bonding is less than 5 seconds, the bonding effect is very limited. In case where the time of the thermal bonding is more than 10 seconds, the leather material 10 is burned to the metal sticker 20 due to excessive fusion.

The shape (flange) of the stiffening plate 30 and the shape (flange) of the jig of the thermal bonding machine may be similar to or identical to the shape (flange) of the metal sticker 20.

The stiffening plate 30 preferably employs stainless steel having a thickness of 1.5 mm or less and an area slightly larger than that of the flange of the metal sticker 20.

According to the above manufacturing process, the inner edge of the attaching groove 13 is slightly shrunk in the thermal bonding process to enclose the flange of the metal sticker 20 in a covering manner, so that the flange of the metal sticker 20 is not exposed from the surface of the leather material 10, but is more stably and firmly attached onto the leather material in the state of being buried inside the attaching groove 13.

In addition, even though the metal sticker 20 is applied by an external force, the metal sticker is not flexibly folded or bent by the stiffening plate 30, thereby effectively preventing the metal sticker from being lifted from the surface of the leather material 10, or from being deformed.

Furthermore, it is possible to prevent the leather material from being thermally deformed and damaged in the laser cutting process by the protective effect of the thin film 40 of surfactant, thereby reducing a defect rate of the leather product.

### Embodiment 3

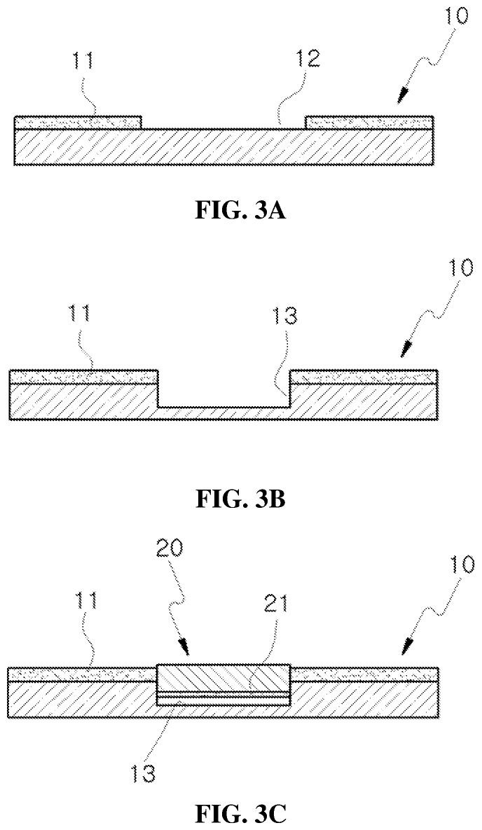

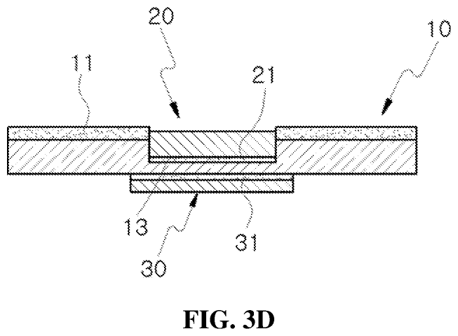

Referring to FIGS. 3A, 3B, 3C and 3D, a method for attaching a metal ornament onto a leather product according to the third embodiment of the present invention generally includes a process (A) of removing a surface coating, a process (B) of forming an attaching groove, a process (C) of temporarily attaching a metal sicker, and a thermal bonding process (D).

(A) Process of Removing Surface Coating

As illustrated in FIG. 3A, the process is to remove a surface coating by precisely burning a part of the surface of a leather material 10 by a laser cutter to have a predetermined shape.

That is, the surface coating 11 of the leather material 10, onto which a metal sticker 20 is attached, is cut by a laser beam to form a removed portion 12 of a predetermined shape having 0.01 to 0.3 mm in depth.

The leather material 10 of the present invention has been subjected to a proper process including chemical and mechanical treatment, such as tanning, dyeing, and painting.

(B) Process of Forming Attaching Groove

As illustrated in FIG. 3B, the process is to form an attaching groove 13 of a certain pattern by hot-stamping the surface of the leather material (10), from which the surface coating was removed, that is, the removed portion 12, with a hot stamping machine or a heat burnishing press.

The attaching groove 13 may be formed in the same pattern as an outer (flange) pattern of a metal sicker 20, such as a trademark, a logo, a design, a product name, or a company name.

That is, the attaching groove 13 of various designs or patterns can be precisely and effectively formed by the laser cutter.

For example, in case of attaching the metal sticker 20 of an ‘ABC’ shape onto the surface of the leather material 10, the surface of the leather material 10 may be provided with the attaching groove 13 by removing the surface of the leather material 10 with the laser cutter so that the surface is recessed to have the same shape as the metal sticker 20 or the corresponding ‘ABC’ shape.

Alternatively, in case of attaching the metal sticker 20 of an ‘⋆’ shape onto the surface of the leather material 10, the surface of the leather material 10 may be provided with the attaching groove 13 by removing the surface of the leather material 10 with the laser cutter so that the surface is recessed to have the same shape as the metal sticker 20 or the corresponding ‘⋆’ shape.

The attaching groove 13 may be formed to have the same depth as a thickness of the metal sticker 20, or to have a depth deeper than that of the metal sticker.

In other words, preferably, the attaching groove 13 guides and support the metal sticker 20 so that the metal sticker does not protrude higher than the surface of the leather material 10, and is maintained in a strongly attached state, and an edge of the metal sticker 20 is not exposed from the surface of the leather material 10 to prevent a user from being injured or the clothes from being damaged due to the protruding edge of the metal sticker.

For example, if the metal sticker 20 is 0.07 to 0.3 mm in thickness, the attaching groove 13 may have a depth of 0.1 to 0.35 mm.

The leather material 10 of the present invention has been subjected to a proper process including chemical and mechanical treatment, such as tanning, dyeing, and painting.

(C) Process of Temporarily Attaching Metal Sticker

As illustrated in FIG. 3C, the process is to temporarily fit and attach the metal sticker 20 having the corresponding shape onto the attaching groove 13.

That is, the metal sticker 20 is preheated so that the metal sticker is temporarily and preliminarily fixed before the metal sticker is bonded integrally with the leather material 10 by a thermal bonding machine.

The metal sticker 20 may be formed in a certain shape, such as a trademark, a logo, a design, a product name, or a company name, and have a bottom surface with an adhesive 21.

(D) Thermal Bonding Process

As illustrated in FIG. 3D, the process is to thermally bond the metal sticker 20 and a stiffening plate 30 after the stiffening plate 30 with the adhesive 31 applied on the bottom surface is put on the rear surface of the leather material 10 at a position corresponding to the metal sticker 20, and then the metal sticker and the stiffening plate are positioned on a jig of the thermal bonding machine.

That is, the metal sticker 20 and the stiffening plate 30 which is placed between an upper plate jig and a lower plate jig are attached onto the leather material 10 by applying heat and pressure to the surfaces of the metal sticker and the stiffening plate.

The thermal bonding process is preferably performed in the range of pressure of 2 to 10 kg/cm² during 5 to 10 seconds at the temperature of 170 to 190° C.

In this instance, in case where the temperature of the thermal bonding is lower than 170° C., the bonding effect is very limited. In case where the temperature of the thermal bonding is higher than 190° C., the leather material 10 is burned to the metal sticker 20.

Also, in case where the time of the thermal bonding is less than 5 seconds, the bonding effect is very limited. In case where the time of the thermal bonding is more than 10 seconds, the leather material 10 is burned to the metal sticker 20 due to excessive fusion.

The shape (flange) of the stiffening plate 30 and the shape (flange) of the jig of the thermal bonding machine may be similar to or identical to the shape (flange) of the metal sticker 20.

The stiffening plate 30 preferably employs stainless steel having a thickness of 1.5 mm or less and an area slightly larger than that of the flange of the metal sticker 20.

According to the above manufacturing process, the inner edge of the attaching groove 13 is slightly shrunk in the thermal bonding process to enclose the flange of the metal sticker 20 in a covering manner, so that the flange of the metal sticker 20 is not exposed from the surface of the leather material 10, but is more stably and firmly attached onto the leather material in the state of being buried inside the attaching groove 13.

In addition, even though the metal sticker 20 is applied by an external force, the metal sticker is not flexibly folded or bent by the stiffening plate 30, thereby effectively preventing the metal sticker from being lifted from the surface of the leather material 10, or from being deformed.

In particular, after the surface coating 11 attached to the surface of the leather material 10 is removed to primarily form the removed portion 12, the attaching groove 13 is formed from the removed portion 12 by the hot stamping manner, thereby easily attaching the metal sticker 20, as compared to the prior art, and reliably preventing the metal sticker 20 from being easily detached due to the attaching force which is decreased by the surface coating 11.

Meanwhile, the metal sticker 20 of the present invention has a thin thickness of 50 to 100 μm, and can be manufactured by the following processes.

(First Process)

The surface of a metal sheet is polished and reformed by a brush.

Specifically, in order to attach a plated sheet of a predetermined shape to the surface of the metal sheet, the surface of the metal sheet is polished by the brush, and then pollutants are cleanly washed out.

For example, after A-21 aluminum oxide powder is introduced into a polishing machine, and the powder is mixed with water, the surface of the metal sheet is polished by an automatic roll brush, and then organic matters and inorganic matters are washed out with weak alkali and weak acid. The process may be performed in combination with electrolytic cleaning or ultrasonic cleaning.

The metal sheet is made of at least one selected from a group consisting of iron, copper, brass, phosphor bronze, cupro-nickel, beryllium copper, stainless steel and nickel, or an alloy thereof.

Preferably, the metal sheet is made of austenitic stainless steel containing Ni of 8 to 11% and Cr of 18 to 20% and having good corrosion resistance to chemical and good heat-resisting property, for example, SUS 304.

(Second Process)

The reformed surface of the metal sheet is applied by photoresist and then is dried.

The photoresist may be a positive photosensitive resin, for example, a positive-type photoresist, which solubilizes a polymer of only the photoresist which is in contact with light.

Preferably, the photoresist is applied at the temperature of 25±5° C., and then is dried for 10 minutes at the temperature of 25±5° C.

(Third Process)

A photo mask with a predetermined pattern printed thereon is attached to the dried photoresist, and then is exposed to ultraviolet rays.

The light source which can be applied to the exposure process may be sunlight, except for ultraviolet rays. A quantity of light is 4 to 16 KW, exposed intensity is 10 to 500 mW/cm², and exposed time is 1 to 500 seconds.

The photo mask consists of a patterned portion, through which the light penetrates at exposure, and an impermeable portion through which the light does not penetrate, and includes, for example, a polyester film, an OPP film and a PET film.

(Fourth Process)

After the exposure process, the portion of the predetermined pattern which is exposed to the ultraviolet rays is dissolved by a developed solution to remove the photo mask.

Specifically, the photoresist of the predetermined pattern is removed by the developed solution. In this instance, the developed solution may be an alkaline solution, such as 3 to 10% sodium carbonate solution, and the developing is carried out by immersing the exposed metal sheet into the developed solution of 10 to 40° C., or spraying the developed solution. The processing time is 10 to 360 seconds.

(Fifth Process)

After the developing, heat treatment is carried out to strengthen the photoresist film.

Preferably, the metal sheet is dried by a heat treatment machine at the temperature of 160±3° C. for 17 to 23 minutes.

(Sixth Process)

The surface of the metal sheet is degreased and washed out to remove pollutants, such as an oxide film and organic matters, attached to the surface.

The degreasing may be carried out by, for example, an electrolytic cleaning method of mechanically destroying and cleaning the oxide film and the organic matters attached to the surface of the metal sheet by a gas generated from electrolysis.

(Seventh Process)

The predetermined pattern formed on the surface of the metal sheet is plated by a strike layer of tin in a thickness of 0.5 to 2 μm.

The striker layer of tin is provided to improve corrosion resistance and reliability of a copper layer. The plating is carried out under conditions, in which the pH range of a plating solution is 25 or less, current density is 1 to 6 A/dm², and a plating time is 120 to 140 seconds, to form a plating layer of 0.5 to 2 μm. The plating solution may be a binary or ternary alloy with no nickel, except for tin.

(Eighth Process)

The tin plating layer is plated by copper in a constant thickness.

The copper plating is carried out to form a necessary thickness. The plating is carried out under conditions, in which the pH range of a plating solution is 8 to 9, current density is 1 to 6 A/dm², a plating temperature is 50 to 60° C., and a plating time is varied depending upon the required thickness, to form a plating layer of 50 to 70 μm. The plating solution may be single metal, or a binary or ternary alloy with no nickel, except for tin.

(Ninth Process)

The copper plating layer is plated by a ternary alloy of Cu—Sn—Zn in a thickness of 0.5 to 10 μm.

The ternary alloy plating layer is carried out to close fine holes of the copper layer and to improve corrosion resistance and wear resistance. The plating is carried out under conditions, in which the pH range of a plating solution is 10 to 14, current density is 3 to 6 A/dm², a temperature is 52 to 58° C., and a plating time is 27 to 33 minutes. The plating solution may be single metal, or a binary or ternary alloy with no nickel, except for the ternary alloy of Cu—Sn—Zn.

(Tenth Process)

The surface of the ternary alloy plating layer of Cu—Sn—Zn is plated by trivalent chromium in a thickness of 0.3 to 0.8 μm.

The trivalent chromium plating is to make the appearance beauty and improve surface hardness. A plating solution is chloride plating bath or sulfuric acid bath.

(Eleventh Process)

The surface of the ternary alloy plating layer is formed with a thin color layer by gold plating or a deposition method to represent a color.

(Twelfth Process)

A protective tape with a proper adhesive force is attached to the surface of the multiple plating layer having the predetermined pattern, and then the multiple plating layers are separated from the metal sheet.

(Thirteenth Process)

The rear surface of the separated multiple plating layer is applied by an adhesive in a thickness of 10 to 20 μm, and then is left at a room temperature or is dried by hot air at a temperature of 50±2° C. for about 120 minutes.

The adhesive may be applied by screen printing, a spray, a roller or the like, and may be attached to a release paper to protect an adhesive surface.

Preferably, the adhesive is a thermosetting adhesive which is cured at a temperature of 100° C. or higher.

For example, an epoxy resin adhesive of two liquid types which has a good mechanical property and a good heat-resisting property after curing and is mixed with two liquids, for example, a main material and a hardener, prior to usage.

While the present invention has been described with reference to the particular illustrative embodiments, it is not to be restricted by the embodiments but only by the appended claims. It is to be appreciated that those skilled in the art can change or modify the embodiments without departing from the scope and spirit defined by the appended claims. Of course, equivalents thereof are contained in the present invention.

The claims and their equivalents are intended to cover such forms or modifications as would fall within the scope and spirit of the inventions.

What is claimed is:

1. A method for attaching a metal ornament onto a leather product comprising the steps of:
forming an attaching groove of a predetermined shape by burning a part of a surface of a leather material with a laser beam;
temporarily fitting and attaching a metal sticker of a corresponding shape to the attaching groove; and
placing a stiffening plate, of which a rear surface is applied by an adhesive, on a rear surface of the leather material at a position corresponding to the metal sticker, and simultaneously attaching the metal sticker and the stiffening plate onto the leather material through thermal bonding,
wherein the metal sticker is manufactured by
a process of polishing and reforming a surface of a metal sheet by a brush,
a process of applying photoresist onto the reformed surface, and drying the photoresist,
a process of attaching a photo mask with a predetermined pattern printed thereon to the dried photoresist, and exposing the photoresist with ultraviolet rays,
after the exposure process, a process of dissolving the portion of the predetermined pattern which is exposed to the ultraviolet rays by a developed solution to remove the photo mask,
after the developing process, a process of heat treating the metal sheet to strengthen the photoresist film,
a process of degreasing and washing out the surface of the metal sheet to remove an oxide film,
a process of plating the predetermined pattern by a strike layer of tin in a thickness of 0.5 to 2 μm,
a process of plating the tin plating layer by copper in a constant thickness,
a process of plating the copper plating layer by a ternary alloy of Cu—Sn—Zn in a thickness of 0.5 to 10 μm,
a process of plating the surface of the ternary alloy plating layer of Cu—Sn—Zn by trivalent chromium,
a process of attaching a protective tape to a surface of the multiple plating layer having the predetermined pattern, and separating the multiple plating layers from the metal sheet, and
a process of applying an adhesive onto a rear surface of the separated multiple plating layer.

2. A method for attaching a metal ornament onto a leather product comprising the steps of:
coating a part of a surface of a leather material with surfactant to form a thin film;
forming an attaching groove of a predetermined shape by burning a part of a surface of a leather material with a laser beam;
removing the thin film of the surfactant and flecks from the leather material;
temporarily fitting and attaching a metal sticker of a corresponding shape to the attaching groove; and
placing a stiffening plate, of which a rear surface is applied by an adhesive, on a rear surface of the leather material at a position corresponding to the metal sticker, and simultaneously attaching the metal sticker and the stiffening plate onto the leather material through thermal bonding,
wherein the metal sticker is manufactured by
a process of polishing and reforming a surface of a metal sheet by a brush,
a process of applying photoresist onto the reformed surface, and drying the photoresist,
a process of attaching a photo mask with a predetermined pattern printed thereon to the dried photoresist, and exposing the photoresist with ultraviolet rays,
after the exposure process, a process of dissolving the portion of the predetermined pattern which is exposed to the ultraviolet rays by a developed solution to remove the photo mask,
after the developing process, a process of heat treating the metal sheet to strengthen the photoresist film,
a process of degreasing and washing out the surface of the metal sheet to remove an oxide film,
a process of plating the predetermined pattern by a strike layer of tin in a thickness of 0.5 to 2 μm,
a process of plating the tin plating layer by copper in a constant thickness,
a process of plating the copper plating layer by a ternary alloy of Cu—Sn—Zn in a thickness of 0.5 to 10 μm,
a process of plating the surface of the ternary alloy plating layer of Cu—Sn—Zn by trivalent chromium,
a process of attaching a protective tape to a surface of the multiple plating layer having the predetermined pattern, and separating the multiple plating layers from the metal sheet, and
a process of applying an adhesive onto a rear surface of the separated multiple plating layer.

3. A method for attaching a metal ornament onto a leather product comprising the steps of:
removing a surface coating of a predetermined shape by burning a part of a surface of a leather material with a laser beam;
forming an attaching groove on the surface of the leather material, from which the surface coating is removed, through hot stamping;
temporarily fitting and attaching a metal sticker of a corresponding shape to the attaching groove; and
placing a stiffening plate, of which a rear surface is applied by an adhesive, on a rear surface of the leather material at a position corresponding to the metal sticker, and simultaneously attaching the metal sticker and the stiffening plate onto the leather material through thermal bonding,
wherein the metal sticker is manufactured by
a process of polishing and reforming a surface of a metal sheet by a brush,
a process of applying photoresist onto the reformed surface, and drying the photoresist,
a process of attaching a photo mask with a predetermined pattern printed thereon to the dried photoresist, and exposing the photoresist with ultraviolet rays,
after the exposure process, a process of dissolving the portion of the predetermined pattern which is exposed to the ultraviolet rays by a developed solution to remove the photo mask,
after the developing process, a process of heat treating the metal sheet to strengthen the photoresist film,
a process of degreasing and washing out the surface of the metal sheet to remove an oxide film,
a process of plating the predetermined pattern by a strike layer of tin in a thickness of 0.5 to 2 μm,
a process of plating the tin plating layer by copper in a constant thickness, a process of plating the copper plating layer by a ternary alloy of Cu—Sn—Zn in a thickness
of 0.5 to 10 m,
a process of plating the surface of the ternary alloy plating layer of Cu—Sn—Zn by trivalent chromium,
a process of attaching a protective tape to a surface of the multiple plating layer having the predetermined pattern, and separating the multiple plating layers from the metal sheet, and
a process of applying an adhesive onto a rear surface of the separated multiple plating layer.

4. The method for attaching the metal ornament onto the leather product according to claim 1, wherein the attaching groove is formed to have a depth equal to or deeper than a thickness of the metal sticker.

5. The method for attaching the metal ornament onto the leather product according to any one of claims 2, wherein the attaching groove is formed to have a depth equal to or deeper than a thickness of the metal sticker.

6. The method for attaching the metal ornament onto the leather product according to any one of claims 3, wherein the attaching groove is formed to have a depth equal to or deeper than a thickness of the metal sticker.
